(19) United States
(12) Patent Application Publication
(10) Pub. No.: US 2019/0252124 A1
(43) Pub. Date: Aug. 15, 2019

(54) ELECTRONIC COMPONENT AND ELECTRONIC SIGNAL PROCESSING UNIT COMPRISING SUCH A COMPONENT

(71) Applicant: SNAPTRACK, INC., San Diego, CA (US)

(72) Inventors: Borys VOROTNIKOV, Munchen (DE); Oleksander RUBAN, Munchen (DE); Mykola SHEVELOV, Munchen (DE); Stefan FREISLEBEN, Neubiberg (DE); Georgiy SEVSKIY, Munich (DE); Patric HEIDE, Vaterstetten (DE)

(21) Appl. No.: 15/759,738

(22) PCT Filed: Aug. 3, 2016
(86) PCT No.: PCT/EP2016/068573

§ 371 Date: Jun. 18, 2018

(30) Foreign Application Priority Data
Sep. 14, 2015 (DE) 10 2015 115 442.0

(51) Int. Cl. H01G 4/38; H01G 4/228

(52) U.S. Cl. CPC H01G 4/38; H01G 4/1209; H01G 4/228

(57) ABSTRACT

The invention relates to an electronic structural element (1) with a first and a second base plate (2a, 2b), as well as a coupling plate (3), wherein, between the first base plate (2a) and the coupling plate (3), a first electrical capacitor (C1) is formed, and, between the second base plate (2b) and the coupling plate (3), a second electrical capacitor (C2) is formed, so that the first and the second electrical capacitors (C1, C2) form an electrical series capacitor (Cs) between the first and the second base plates (2a, 2b). According to the invention, the coupling plate (3) is divided into a plurality (N) of mutually non-contacting strips (6), wherein the first and the second electrical capacitors (C1, C2) are in each case divided into a plurality (N) of electrical elementary capacitors (Ce), and, by means of the strips (6), a plurality (N) of parallel-connected, electrical elementary series capacitors (Cse) is formed between the first and the second base plates (2a, 2b). This way, a short circuit (K) on a specific strip (6′) has only a slight effect on a change in the overall series capacitance (Cs) on the structural element (1).

The invention relates to an electronic structural element, which has at least a first and a second base plate, as well as a coupling plate, wherein, between the first base plate and the coupling plate, a first electrical capacitor is formed, and, between the second base plate and the coupling plate, a second electrical capacitor is formed, so that the first and the second electrical capacitors form an electrical series capacitor between the first and the second base plates.

Electronic structural elements of this type find wide application as so-called cascaded capacitor components in electronic signal-processing units, such as SAW or BAW filters (SAW stands for Surface Acoustic Wave; BAW stands for Bulk Acoustic Wave), signal extractors, multiplexers, radio frequency (RF) or high-frequency modules, and so on.

During the manufacture of such cascaded capacitor components, a short-circuit may form between individual components of the structural element for manufacture-related reasons. Such a short circuit may occur in very small affected areas of the structural element, but can have significant effects. For example, in the case of two capacitors connected in series in a structural element of the type described above, a short circuit can lead to one of the two capacitors being short-circuited.

The problem with such short circuits occurring is that the total capacitance of the structural element is significantly changed. In the case of a short-circuit of one of two equally-dimensioned capacitors of a series capacitor, this can, for example, result in the total capacitance of the series capacitor doubling. Such changes in capacitance can cause a significant deterioration in the performance of the structural element and ultimately result in the entire component failing.

Previously, a problem of this kind was combated by technological improvements in the manufacturing process or the process quality. Such approaches, however, involve enormous investments and only partially avert a danger of short circuits in the structural elements, with the consequences described.

It is an aim of the present invention to protect, in a simple, yet effective, way, electronic structural elements of the above-mentioned kind from significant effects of a short-circuit formation in the structural element or to drastically reduce the impact of a short-circuit formation.

This aim is achieved by an electronic structural element of the type mentioned initially, in that the coupling plate is divided into a plurality of mutually non-contacting strips in such a way that the first and the second electrical capacitors are in each case divided into a plurality of electrical elementary capacitors, and, by means of the strips, a plurality of parallel-connected, electrical elementary series capacitors is formed between the first and the second base plates.

The advantage of a structural element designed in this way is that a short circuit in a relatively small area of the structural element has considerably less impact than in conventional structural elements of this type. Due to the fact that the coupling plate is divided into a plurality of mutually non-contacting strips, a short circuit in a relatively small area of the coupling plate affects only one or just a few strips. This means that also only one or a few elementary capacitors between the coupling plate and the first or the second base plate will be short-circuited. Accordingly, only the capacitance of one or a few elementary series capacitors along one or a few strips of the coupling plate will be changed. As a result, the total capacitance of the electronic structural element is subjected to only very small changes. In this way, a short circuit in a small area of the structural element will have only a slight effect on the functionality and the operating behavior of the structural element.

The general advantage of the present invention is thus that overall quality and the quality of the structural element can be dramatically improved by simple construction measures and minor design changes to the structural element, without the need for costly changes in the manufacturing process of the structural element.

According to one embodiment, the strips of the coupling plate extend in their longitudinal direction in such a way that in each case they cover not only a part of the first base plate, but also a part of the second base plate, so as to form the electrical elementary capacitors. Advantageously, the strips of the coupling plate are identically dimensioned—within the context of deviations tolerable in manufacturing—thus having a uniform length and width. In this way, the elementary capacitors formed at each strip between the first or the second base plate and the coupling plate are of substantially identical dimensions. This has the effect that a short circuit on one strip of the coupling plate has an impact which is almost identical to that of a short circuit on a different strip of the coupling plate. If a short circuit occurs on a strip of the coupling plate, its effects are foreseeable and can be predicted precisely. Furthermore, it is conceivable to compensate for this by means of, for example, electronic compensation circuitry or closed-loop compensation control.

In one embodiment, the distance between—in each case—two strips of the coupling plate is at least one order of magnitude smaller than the width of a respective strip. For example, if the width of a strip is 15 μm, the distance between two strips will be only 1 μm. The advantage of such dimensioning is that dividing the coupling plate into the plurality of strips has only a very small impact on the dimensions of the entire structural element, and these can be almost unchanged in comparison with conventional devices. The changes in the design of the coupling plate in the way described above thus have no, or very little, impact on the dimensions of the structural element.

In one embodiment, the structural element is given a multi-layer construction, wherein the first and second base plates form a lower layer, the coupling plate forms an upper layer, and an intermediate layer is formed between the lower and upper layers. In one embodiment, the first and second base plates, as well as the coupling plate, are made of electrically conductive material, wherein the intermediate layer is a dielectric. For example, the intermediate layer can be a silicon oxide—for example, silicon dioxide (SiO₂). Furthermore, materials such as lithium niobate (LiNbO₃) or lithium tantalate (LiTaO₃) come into consideration. Other materials are also conceivable, depending upon the design and application of the structural element.

The electronic device of the type described advantageously finds application in an electronic signal-processing unit, wherein the signal-processing unit takes the form of a SAW or BAW filter, signal extractor, multiplexer, radio frequency module, or a combination thereof.

The invention is explained in more detail below, with reference to several figures.

Shown are:

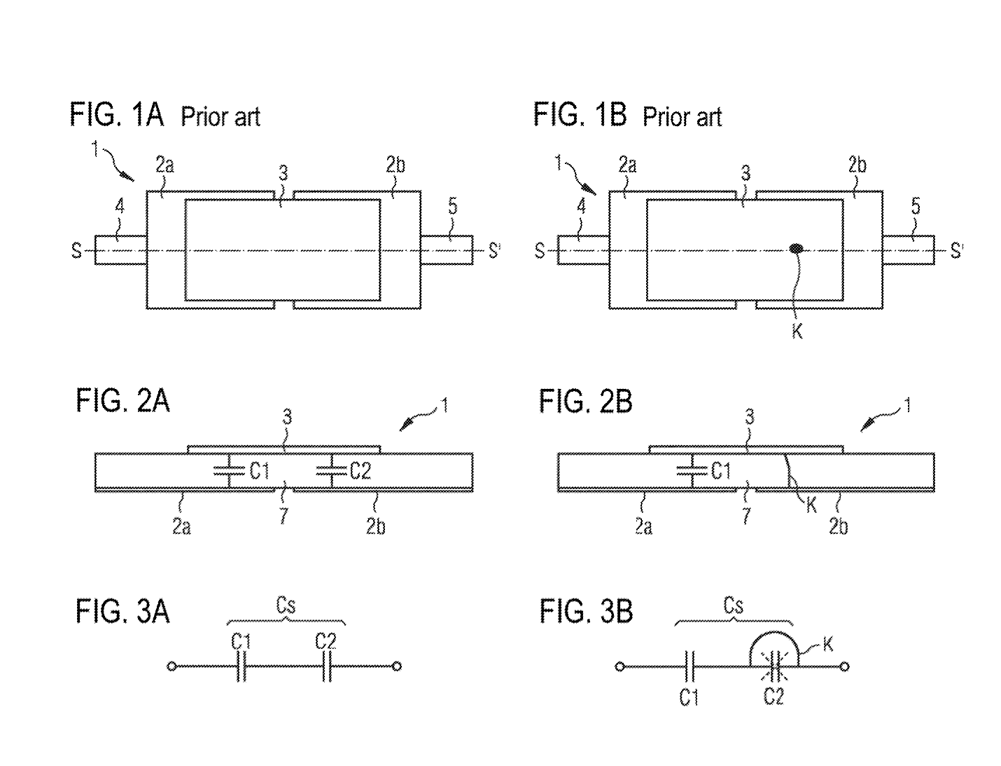

FIG. 1A schematic plan view of an electronic structural element according to prior art,

FIG. 1B the plan view, according to FIG. 1A, in which a short circuit occurs,

FIG. 2A a sectional view of the structural element according to FIG. 1A along the section axis S-S′,

FIG. 2B a sectional view of the structural element according to FIG. 1B along the section axis S-S′,

FIG. 3A an equivalent circuit diagram of the structural element according to FIGS. 1A and 2A,

FIG. 3B an equivalent circuit diagram of the structural element according to FIGS. 1B and 2B,

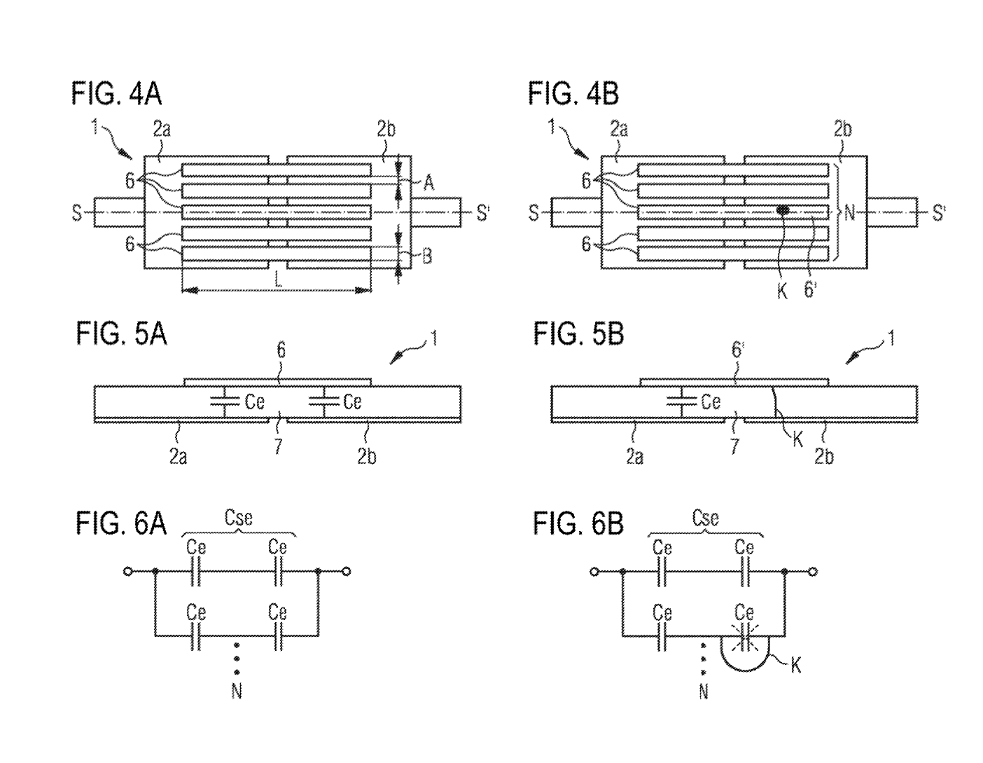

FIG. 4A a schematic plan view of an embodiment of an electronic structural element according to the invention,

FIG. 4B the plan view, according to FIG. 4A, in which a short circuit occurs,

FIG. 5A a sectional view of the structural element according to FIG. 4A along the section axis S-S′,

FIG. 5B a sectional view of the structural element according to FIG. 4B along the section axis S-S′,

FIG. 6A an equivalent circuit diagram of the structural element according to FIGS. 4A and 5A, and

FIG. 6B an equivalent circuit diagram of the structural element according to FIGS. 4B and 5B.

FIG. 1A shows an electronic structural element 1 according to the prior art. The structural element 1 has a first base plate 2a and a second base plate 2b, as well as a coupling plate 3. In addition, a first electrical connection contact is arranged on the first base plate 2a and here functions as the input 4 of the structural element 1. A second connection contact is arranged on the second base plate 2b and here functions as the input 5 of the structural element 1. With the two connection contacts 4 and 5, the structural element 1 can, in an electronic circuit, be electrically contacted with other components.

The structural element 1 takes the form of a capacitor component with a series capacitor between the first and the second base plates 2a and 2b. Specifically, a first electrical capacitor C1 is formed between the first base plate 2a and the coupling plate 3, and a second electric capacitor C2 is formed between the second base plate 2b and the coupling plate 3 (see the schematic indication in FIG. 2A). The first and the second electrical capacitors C1 and C2 form an electrical series capacitor Cs between the first and the second base plates 2a and 2b. This electrical behavior of the structural element 1 is also clarified in the equivalent circuit diagram according to FIG. 3A. If, for example, the capacitors C1 and C2 are dimensioned identically and in each case have the capacitance C, the electrical series capacitance Cs of the circuit is calculated thus:

Cs=C/2.

The structural element 1 has a multi-layer design, wherein the first and second base plates 2a and 2b form a lower layer, the coupling plate 3 forms an upper layer, and an intermediate layer 7 is formed between the lower and upper layers (see structure in FIG. 2A). In particular, the first and second base plates 2a and 2b, as well as the coupling plate 3, are made of electrically conductive material. The intermediate layer 7 is a dielectric. The intermediate layer 7 can be a silicon oxide—for example, silicon dioxide (SiO₂). Furthermore, depending upon the application of the structural element 1, materials such as lithium niobate (LiNbO₃) or lithium tantalate (LiTaO₃) come into consideration for the intermediate layer.

FIG. 1B shows the structural element 1 in accordance with the structure in FIG. 1A, wherein, in the area of the second base plate 2b, an electrical short-circuit K occurs between the coupling plate 3 and the second base plate 2b. Such a short-circuit K can, for example, occur during the manufacturing process of the structural element 1, for reasons relating to that process. Due to the short circuit K, the second electrical capacitor C2 between the coupling plate 3 and the second base plate 2b is electrically bridged, as illustrated in FIGS. 2B and 3B. The overall capacitor Cs will then be formed solely by the capacitor C1. In this regard, compare FIG. 3B. If the capacitance C is still assumed for the capacitor C1, the total series capacitance Cs is now calculated according to FIG. 3B as Cs=C.

Due to the short-circuit K, the total capacitance Cs has thus doubled in comparison with the constellation according to FIGS. 1A, 2A, and 3A. The capacitance Cs of the structural element 1 has thus changed significantly as a result of the short circuit K, as shown in FIGS. 1B, 2B, and 3B. Such a change in capacitance can cause a significant deterioration in the performance of the structural element and ultimately result in the entire structural element 1 failing.

To circumvent such a problem, FIG. 4A shows a possible embodiment of an electronic structural element 1 according to the invention. The structural element 1 is essentially constructed in the same way as the structural element 1 according to FIG. 1A. However, the coupling plate 3 is divided into a plurality of strips 6, which extend between the first and second base plates 2a and 2b in a longitudinal direction with the length L in such a way that the strips 6 in each case cover not only a part of the first base plate 2a, but also a part of the second base plate 2b, so as to form electrical capacitors. In this way, the strips 6 fulfill a functionality comparable to that of the coupling plate 3 according to FIG. 1A.

In contrast to the form taken by the structural element 1 in FIG. 1A, at each strip 6, in each case with respect to the first and second base plates 2a and 2b, electrical elementary capacitors Ce are formed, wherein two electrical elementary capacitors Ce in each case form an electrical elementary series capacitor Cse along each strip 6 between the first and the second base plates 2a and 2b. In this regard, see also the sectional view in FIG. 5A along the section axis S-S′ from FIG. 4A.

All of the strips 6 (five strips are arranged in the embodiment according to FIG. 4A) together form a plurality of parallel-connected, electrical elementary series capacitors Cse, as the equivalent circuit diagram in FIG. 6A shows. With five strips 6, five parallel-connected elementary series capacitors Cse thereby result. If, in each case, a capacitance value C is still assumed for the total electrical capacitance between the strip 6 and the first base plate 2a, or between the strip 6 and the second base plate 2b, the value of an elementary capacitor Ce will be the value Ce=C/N, where N is the number of strips 6 (in the embodiment according to FIG. 4A, N=5). An elementary electrical series capacitor Cse along a strip 6 thus has the value:

Cse=Ce/2.

The total series capacitance Cs of the structural element 1, which is made up of the sum of the parallel-connected elementary series capacitors Cse, can thus be calculated on the basis of the circuitry as:

Cs =N×Ce/2.

Substituting the above value for the elementary capacitance Ce yields, analogously to the explanations in accordance with FIG. 3A, for the entire series capacitance Cs, the value:

Cs=C/2.

The strips 6 have a predetermined length L and a predetermined width B and are arranged so as not to be in mutual contact at, in each case, a distance A in such a way that they simulate in their functionality the coupling plate 3 according to FIG. 1A. The distance A between, in each case, two strips 6 can, for example, be at least an order of magnitude smaller than the width B of a respective strip 6. Specifically, the strips 6 have, for example, a width B of 15 μm, while the distance A is 1 μm. Other sizes and dimensions are of course possible, depending upon the application. Dimensioning in this way means that the external dimensions of the structural element 1 remain essentially unchanged, in comparison with the embodiment according to FIG. 1A. In spite of the modified design of the contact plate 3 divided into strips 6, the dimensions of the electronic structural element 1 thus remain almost unchanged, compared with conventional designs.

FIG. 4B shows the structural element 1 according to FIG. 4A, wherein, in a particular strip 6′, an electrical short circuit K occurs between the strip 6′ and the second base plate 2b. Due to the short circuit K, the elementary capacitor Ce is electrically bridged between the strip 6′ and the second base plate 2b, as is shown by the sectional view in FIG. 5B along the section axis S-S′ according to FIG. 4B and also by the equivalent circuit diagram in FIG. 6B.

The division of the contact plate 3 into the plurality of strips 6 has the advantage that, due to the short circuit K, which relates only to the particular strip 6′, only a single elementary capacitor Ce on the specific strip 6′ is bridged (see FIG. 6B). Accordingly, the capacitance increases from Cse=Ce/2 to Cse=Ce only along a single elementary series capacitor Cse on the specific strip 6′. All of the other elementary series capacitors Cse continue to be formed electrically from the parallel connection of two elementary capacitors Ce and in each case have the unchanged value, Cse=Ce/2. In the case of the short circuit K, according to FIG. 4B and FIG. 5B, the entire capacitance of the structural element 1 can be calculated as:

Cs=(N−1)Ce/2+Ce.

In the case of multiple short circuits—K in number—the total capacitance can, in general, be calculated as:

Cs=(N−K)Ce/2+CeK.

If, for the constellation according to FIGS. 4B and 5B, Ce=C/N is again used for an elementary capacitor Ce, the following value for the total capacitance according to the equivalent circuit diagram in FIG. 6B results:

Cs=C/2+C/2N.

In the case of N=5 strips 6, in the individual short-circuit case as shown in FIGS. 4B, 5B, and 6B, the total capacitance, in comparison with the constellation according to FIGS. 4A, 5A, and 6A, changes from Cs=C/2 to Cs=2+C/10.

In this way, in the case of a structural element 1 according to the embodiment in FIG. 4A, when a single short circuit occurs as shown in FIG. 4B, the total capacitance Cs changes only slightly in comparison with the total capacitance when there is no short circuit. On the basis of simple modifications of the coupling plate 3 by dividing it into a plurality of strips 6, a short-circuit problem in the structural element 1 can thus be combated in a simple, but nonetheless effective way. In the event of a short circuit, the capacitance changes only slightly, such that the performance of the structural element is maintained.

In embodiments not shown, instead of two base plates 2a and 2b, a structural element 1 may have, for example, four, six, eight, or any even number of base plates, which are connected in series via corresponding coupling plates 3, each of which overlaps two base plates so that the corresponding capacitors C1 and C2 are created between a particular coupling plate and corresponding base plates. All of the coupling plates 3 are advantageously divided into a plurality of strips 6, as shown in FIG. 4A.

Electronic structural elements 1 of the type described advantageously find application in electronic signal-processing units, which take the form of, for example, SAW or BAW filters, signal extractors, multiplexers, radio frequency modules, or a combination thereof.

All of the illustrated embodiments have been selected solely as examples.

### LIST OF REFERENCE SIGNS

electronic structural element
2a, 2b base plates
3 coupling plate
4 input
5 output
6 coupling plate strips
6′ specific strips of the coupling plate
7 intermediate layer
A distance
B width of a strip
C1, C2 first/second capacitor
Cs series capacitor
Ce elementary capacitor
Cse elementary series capacitor
K short-circuit path
L length of a strip
N number of strips
S-S′ section axis

1. Electronic structural element (1) at least having a first and a second base plate (2a, 2b), as well as a coupling plate (3), wherein, between the first base plate (2a) and the coupling plate (3), a first electrical capacitor (C1) is formed, and, between the second base plate (2b) and the coupling plate (3), a second electrical capacitor (C2) is formed, so that the first and the second electrical capacitors (C1, C2) form an electrical series capacitor (Cs) between the first and the second base plates (2a, 2b),
characterized in that
the coupling plate (3) is divided into a plurality (N) of mutually non-contacting strips (6) in such a way that the first and the second electrical capacitors (C1, C2) are in each case divided into a plurality (N) of electrical elementary capacitors (Ce), and, by means of the strips (6), a plurality (N) of parallel-connected, electrical elementary series capacitors (Cse) is formed between the first and the second base plates (2a, 2b).

2. Electronic component (1) according to claim 1, wherein the strips (6) of the coupling plate (3) extend in their longitudinal direction (L) in such a way that in each case they cover not only a part of the first base plate (2a), but also a part of the second base plate (2b), so as to form the electrical elementary capacitors (Ce).

3. Electronic component (1) according to claim 1 or 2, wherein the distance (A) between each two strips (6) of the coupling plate (3) is at least one order of magnitude smaller than the width (B) of a respective strip (6).

4. Electronic component (1) according to one of claims 1 through 3, wherein the structural element (1) has a multi-layer design, wherein the first and second base plates (2a, 2b) form a lower layer, the coupling plate (3) forms an upper layer, and an intermediate layer (7) is formed between the lower and upper layers.

5. Electronic component (1) according to claim 4, wherein the first and second base plates (2a, 2b), as well as the coupling plate (3), are made of electrically conductive material, and the intermediate layer (7) is a dielectric.

6. Electronic signal-processing unit, having at least one electronic component (1) according to one of claims 1 through 5, wherein the signal-processing unit takes the form of a SAW or BAW filter, signal extractor, multiplexer, radio frequency module, or a combination thereof.
